(19) United States
(12) Patent Application Publication
(10) Pub. No.: US 2008/0122575 A1
(43) Pub. Date: May 29, 2008

(54) Remote configuration of security-oriented devices

(76) Inventors: Yoel Lavian, Ganei-Tikva (IL); Steven Benjamin Graniewitz, Ramat Gan (IL)

Correspondence Address: EMPK & Shiloh, LLP, 116 JOHN ST,, SUITE 1201, NEW YORK, NY, 10038, US

(21) Appl. No.: 11/603,906

(22) Filed: Nov. 24, 2006

(51) Int. Cl. G05B 23/02

(52) U.S. Cl. 340/3.1

(57) ABSTRACT

A 2-way wireless security system is provided, which may include a control system adapted to remotely configure security-oriented peripherals; and one or more security-oriented peripherals, each of which may be adapted to be wirelessly configured by said control system. The control system may be adapted to bi-directionally and wirelessly communicate with the one or more security-oriented peripherals.

### FIELD OF THE DISCLOSURE

The present disclosure relates generally to the field of security systems. More specifically, the present disclosure relates to security system peripherals that can be configured and controlled remotely, such as by a security control panel.

### BACKGROUND

Intrusion, fire and safety alarm systems are widely used for protecting offices, apartments and restricted places/areas in general. A typical security system may include one or more wireless security-oriented peripherals such as (the list not being exhaustive) motion detectors (for example Passive InfraRed, “PIR”, an electronic device designed to detect motion of an infrared emitting source, usually a human body), different kinds of security and safety sensors, proximity switches, smoke detectors, water leakage detectors, and other types of sensors/devices. Such sensors, which are installed in locations of interest (for example in a room, lobby or doorstep) that are to be protected, are typically connected to a local control panel that is usually installed within, or in proximity to, the protected property and connected to a suitable means, for example to a remote central station, for announcing or reporting an alarm event, and, hopefully, eliciting or invoking a corresponding response.

A local control panel of a wireless security system typically includes, or have associated with it, a wireless keypad by which a user can set (arm or enable) a security system and stop (disarm or disable) an activated security system by typing or keying in a corresponding alphanumeric code. Once a code is keyed in, the security system may either be set or stop, depending on the previous and desired states of the security system. Depending on the type, sophistication and complexity of the security system, it may allow a user, for example, to arm and disarm the security system in respect of selected areas, for example by typing in corresponding code(s). The user may instruct the security system to do other operations, such as permitting other users to operate the security system (partially or wholly), and so on. Depending on the used peripherals, security systems may offer a user several operational modes or options from which the user may choose one or more options.

Some security systems are dedicated to one mission or task (identifying intrusion, for example), others may handle several missions or tasks, for example, identifying fire, intrusion, and safety alarms. Motion detectors and other security and safety sensors, and security-oriented peripherals (herein referred to also as “peripherals”) in general, are selected according to the security application requirements, mission(s) or task(s). That is, they are selected according to the mission(s) assigned to, or tasks that are to be carried out by, the security system and, often, peripherals can, or allowed to, be configured to operate in certain way(s) or mode(s) of operation.

Optimizing a security system usually requires reconfiguration of one or more of the associated wireless peripherals. However, traditional configuration of peripherals (wireless and others) typically involves manual changes in the on-board dual in-line package switches (“DIP-switch”, an electric switch packaged in a standard dual in-line package) and/or jumpers (“jumper” is two or more electrical connecting points that can be conveniently shorted together electrically) to set up, adjust or change the functionality of an electronic circuit (usually a printed circuit board (PCB)) to thereby enable the required or desired mode(s) of operation and/or security system's optimization process.

Therefore, configuration (and thereafter, if required, reconfiguration) of security related peripherals is traditionally done on-site (at the security system's location), by the security system's installer or by a maintenance or other qualified person. For example, if a large number of false alarms are received from a certain PIR detector after its installation, often due to improper pulse-count configuration setting, the system's installer or maintenance person traditionally has to be at the scene (the security installation site), open the detector's housing and re-configure the pulse counter to a different setting in order to reduce the detector's sensitivity and, thereby, the number of false alarms. Because the installation of security detectors largely depends on physical characteristics (width, length, height, location of walls and windows, obstacles, and so on) of the protected place/area, it generally involves having a compromise between the security system's performance and false alarm immunity. Therefore, installation of security detector(s) is traditionally done using a trial-end-error methodology. That is, a technician installing security detector(s) usually guesses (or applies rules of thumb as to) what the setting of detection parameters (such as detection distance and angle, pulse-count, and so on) should be, and manually configures the detector(s) accordingly, by setting corresponding DIP-switch(es) and/or jumper(s) associated with the configured security detector(s).

Configuring security detectors in the traditional manner (setting DIP-switches and/or jumpers) have several drawbacks. For example, a person installing the security system with pre-planned detector(s), may configure a detector in a way that false alarms may occur. For example, it may occur that the DIP-switch(es) and/or jumper(s) set by the system installer cause(s) the detector to work well at certain hours of the day but not for other hours, due to environmental changes, for example because the sensitivity of the detector(s) involved may change as a function of the sun's direction relative to the installation location of the detector(s) or the environmental temperature has changed dramatically. As a result of this, the system's installer may have to spend a considerable amount of time in returning to the installation site and reconfiguring problematic detector(s). In some cases, several manual reconfiguration iterations may be required before an optimal detector(s) installation is reached, which is an inefficient and costly procedure. Therefore, there has been a long felt need in the security arena to overcome, or mitigate, these, and other kinds of, installation obstacles, for example by using 2-way wireless peripherals instead of the traditional 1-way wireless peripherals.

With the advent of the Internet, rise of home networking, development of communication protocols and remote controllers, configuring security-related peripherals may be done remotely and easily, and without requiring DIP-switches or jumpers. The capability to remotely configure security-related peripherals is of significant importance because, in many cases, a successful configuration setting can only be perceived over time and under different circumstances.

Another drawback of traditional 1-way wireless peripherals is that they cannot be activated or operated based on the general security system's status. For example, if a sensor (for example a PIR device) sends a message to the involved control panel (such as when the sensor detects an alarm condition) the sensor (in a 1-way system) does not “know” whether the message it sent was actually received at the intended recipient (usually the involved control panel), for a sensor (for example) in a 1-way security system is incapable of receiving a feedback signal from the control panel (for example), which confirming that the message was indeed received at the control panel. In a 2-way security system, however, the control panel may confirm safe receipt of a message sent by a sensor (for example) and, failing to receive a confirmation signal, the (2-way) sensor may re-send the alarm message again, until it receives the confirmation signal, or until another predetermined condition prevails.

### Glossary

“Security-oriented peripheral” means herein any wireless device or system already mentioned herein (for example a motion detector, gas detector, and so on) and, in addition, wireless keypads, key fobs and repeater (also called a “Wireless Range Extender”), which is adapted to interact, or capable of interacting with a security control panel.

An electronic “Key fob” is a device used for remote keyless entry systems. Early key fobs operated using infrared and required a clear line of sight to function. More recent models use challenge-response authentication over radio frequency (RF). Key fobs are increasingly used in apartment buildings for access to common areas such as lobby doors, storage areas, fitness room, pool, and so on. Key fobs can be programmed to allow access only to those areas in which the tenant or owner is permitted to access, or only within certain time frames.

“1-way wireless system” means herein a traditional security system that typically includes detectors and/or sensors (for example), and possibly other kinds of security-related peripherals, capable of transmitting (usually security-oriented) information to a control panel (for example), but that are incapable of receiving configuration or control instructions (or other kind of instructions or data for that matter).

“2-way wireless system” means herein a security system that may include detectors and/or sensors (for example), and possibly other kinds of security-related peripherals, capable of both transmitting (usually security-oriented) information or data to a control panel (for example) and receiving configuration data, information and/or instructions (or other kind of instructions and/or information or data for that matter).

“Firmware” is a category of memory chips that hold their content without electrical power. Firmware includes flash, ROM (Read-Only Memory), PROM (Programmable ROM), EPROM (Erasable PROM) and EEPROM (Electronically Erasable PROM) technologies. When holding program instructions, firmware can be thought of as “hard software”.

“Global System for Mobile Communications” (“GSM”) is a cellular network, which means that mobile phones connect to it by searching for cells in the immediate vicinity. GSM networks operate in four different radio frequencies. Most GSM networks operate in the 900 MHz or 1800 MHz bands. Some countries in the Americas (including the USA and Canada) use the 850 MHz and 1900 MHz bands because the 900 and 1800 MHz frequency bands were already allocated.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

As part of the present disclosure there is provided a 2-way wireless configuration and control system adapted to remotely configure security-oriented peripherals. The 2-way wireless system may include a control panel (or a “security-oriented peripheral control system” in general) adapted to bi-directionally and wirelessly communicate with one or more security-oriented peripherals, each of which may be adapted to be configured, controlled, monitored, and/or otherwise handled, by the control system.

As part of the present disclosure a security-oriented peripheral may be, for example, a configurable security detector (“CSD”). According to an embodiment of the present disclosure a CSD may include a detection means (for example, but not limited to transducer or Passive Infrared detection element (PIR)) for sensing a physical property (for example, irradiated heat, exerted pressure or force, and so on) or a change thereof, and outputting a signal representative of the sensed physical property or change thereof. The CSD may further include a processing means for conditioning (filtering, amplifying and so on) and processing the signal outputted by the detection means.

The CSD may further include an actions module for translating the conditioned and/or processed output signal to corresponding alarm-related actions. “Alarm-related actions” generally refers herein to actions corresponding to the interpretation of, or actions resulting from, signal(s) generated by the detection means. For example, responsive to an “alarm” message sent from a CSD to a control system, the control system may operate an alarm buzzer and/or send a message to a remote monitoring station and/or send a SMS message to a person, and so on, all of which are exemplary alarm-related actions.

The CSD may further include a bi-directional wireless communication module (“WCM”) for bi-directionally communicating with a control system, the communication there between may include exchanging configuration data and/or configuration-related data, and possibly other kinds of information and/or instruction(s). According to an embodiment of the present disclosure the CSD's bi-directional wireless communication module (WCM) may enable communication of action data to the remote device, apparatus or system (usually a control panel) to which the CSD is functionally coupled. A WCM may include radio frequency (RF) receiver(s) and RF transmitter(s), or wireless receiving and transmitting means of other kinds (for example optical receiving and transmitting means).

As part of the present disclosure a security-oriented peripheral may be a configurable wireless keypad (“CWK”), which may be remotely configured, and generally controlled, by the control system. According to an embodiment of the present disclosure the CWK may include a bi-directional WCM for bi-directionally communicating with a remote device, apparatus or system (usually an alarm control panel), the communication there between may include exchanging configuration-related data, information and/or instruction(s).

As part of the present disclosure a security-oriented peripheral may be a configurable wireless repeater (“CWR”), which may be remotely configured, and generally controlled, by the control system. According to an embodiment of the present disclosure the CWR may include a bi-directional WCM for bi-directionally communicating with a remote device, apparatus or system (usually an alarm control panel), the communication there between may include exchanging configuration-related data, information and/or instruction(s).

As part of the present disclosure a security-oriented peripheral may be a configurable wireless Siren (“CWS”), which may be remotely configured, and generally controlled, by the control system. According to an embodiment of the present disclosure the CWS may include a bi-directional WCM for bi-directionally communicating with a remote device, apparatus or system (usually an alarm control panel), the communication there between may include exchanging configuration-related data, information and/or instruction(s).

The control system may also have a bi-directional WCM for enabling communication with its associated CSD(s), CWK(s), CWR(s) and/or CWS(s) (through the respective bi-directional WCM), whichever the case may be. The bi-directional communication between the involved bi-directional WCMs may be implemented using a general-purpose, dedicated or proprietary communication technology or protocol.

According to an embodiment of the present disclosure wireless communication between a CSD, CWK, CWR or CWS and an associated control system (for example) may include, among other things, receiving at the security-oriented peripheral (through the involved bi-directional WCMs) instructions for replacing, modifying, updating or changing the configuration of the CSD, CWK, CWR or CWS, respectively.

According to an embodiment of the present disclosure a CSD, CWK, CWS and CWR may each be configured either locally and/or remotely, in both options through the control system to which the CSD, CWK, CWS and CWR are functionally coupled. By “configured locally” is meant configuring the CSD, CWK, CWS or CWR (whichever the case may be) by keying configuration and/or configuration-related data and/or instruction(s) into the control system (by using the control panel's, or control system's, keypad). By “configured remotely” is meant configuring the CSD, CWK, CWS or CWR (whichever the case may be) by forwarding configuration and/or configuration-related data and/or instructions, for example from a personal computer (“PC”), to the involved control system, over a communication network, which may be, for example, a Plain Simple Telephone Network (“PSTN”), Global System for Mobile Communications (“GSM”) or the Internet, or any combination thereof.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 is a schematic block diagram of an exemplary traditional detector;

FIG. 2 is a schematic block diagram of an exemplary configurable detector according to an embodiment of the present disclosure;

FIG. 3 is a general security configuration system according to an embodiment of the present disclosure; and

FIGS. 4, 5 and 6 schematically illustrate remote configuration, Standby/Shutdown and remote firmware update, respectively, according to an embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate like elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, “deciding”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include an apparatus for performing the operations described herein. This apparatus may be specially constructed for the desired purposes, or it may comprise a general-purpose computer selectively activated or reconfigured by a computer program stored in the computer.

Network adapters may also be coupled to the system to enable the data processing system to become coupled to other data processing systems or remote printers or storage devices, or the like, through intervening private, public or other networks. Modems, cable modem and Ethernet cards are just a few of the currently available types of available network adapters.

The processes and displays presented herein are not inherently related to any particular computer or other apparatus. Various general-purpose systems may be used with programs in accordance with the teachings herein, or it may prove convenient to construct a more specialized apparatus to perform the desired method(s) or develop the desired system(s). The desired structure(s) for a variety of these systems will appear from the description below. In addition, embodiments of the present disclosure are not described with reference to any particular programming language. It will be appreciated that a variety of programming languages may be used to implement the teachings of the disclosures as described herein.

Referring now to FIG. 1, it generally shows, by way of example, a traditional layout and functionality of a security detector (generally shown at 100). Although different kinds of security detectors exist, the functionality of many of them may be characterized likewise, by being roughly partitioned into three main functions, sections, portions or modules, as is shown and described in connection with security detector 100.

Security detector 100 may include a sensor (shown at 101), processor (shown art 102), and actions module (shown at 103). Sensor 101 may sense a physical property (for example, irradiated heat) or a change thereof and output a signal representative of, or corresponding to, the sensed physical property or change(s) thereof. Processor 102 may be used for conditioning (filtering, amplifying, and so on) and processing the signal outputted and forwarded (shown at 111) by sensor 101. Actions module 103 may translate the conditioned or processed output signal, forwarded (shown at 112) to it by processor 102, into corresponding alarm-related actions. Actions module 103 may include a decision means for determining the corresponding alarm-related actions, and a 1-way communication module for transmitting (shown at 120) alarm related messages to a control system such as control panel 110.

Traditionally, actions module 103 is intended, and accordingly designed, to forward (shown at 120) security-related actions to a remote device, usually to a security control panel such as control panel 110. That is, if the signal forwarded (shown at 111) by sensor 101 to processor 102 is interpreted by processor 102 as an alarm indication, actions module 103 may typically forward (shown at 120) to control panel 110 a corresponding notice. However, a traditional security detector such as security detector 100 is not intended to be, nor it is capable of being, configured or controlled by the remote device (in this example by control panel 110) to which it is functionally coupled.

As is explained earlier, conventional security detectors such as security detector 100 may be manually configured to operate in one of several modes of operation, by changing (by a technician, for example) the setting of on-board DIP-switch(s) and/or jumper(s). The ability to manually switch between modes of operation is schematically designated as 131 and 132. Reference numeral 131 may represent the ability to manually change the sensitivity of sensor 101, and reference numeral 132 may represent the ability to manually change the way the output signal of sensor 101 may be manipulated.

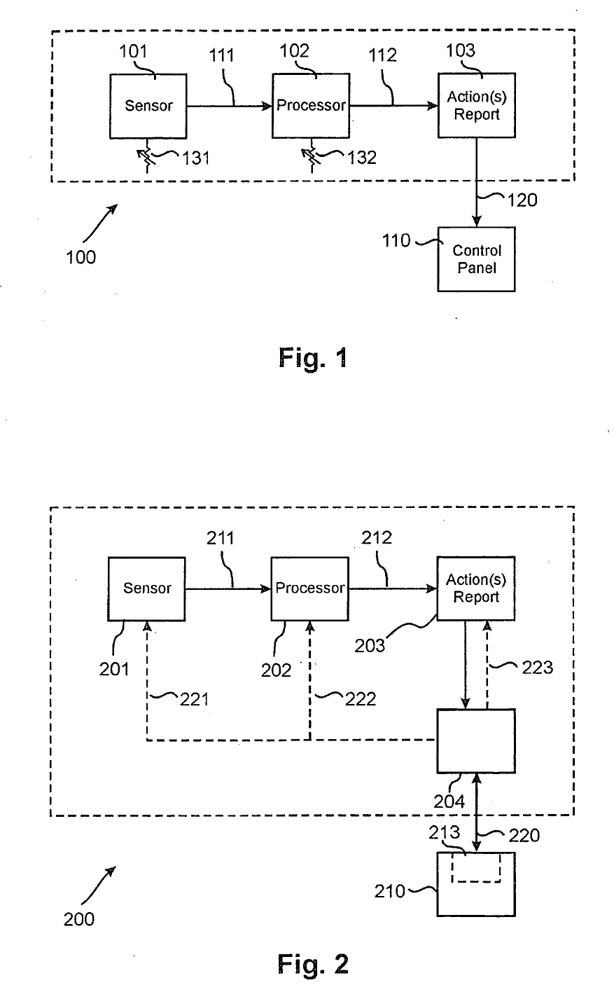

Referring now to FIG. 2, it shows, by way of example, a general layout and functionality of an exemplary configurable security detector (CSD) (generally shown at 200) according to an embodiment of the present disclosure. Configurable security detector (CSD) 200 may include a sensor (shown art 201) which may be similar to sensor 101 of FIG. 1, processor (shown at 202) which may be similar to processor 102 of FIG. 1, and actions module (shown at 203) which may be similar to, or an upgraded version of, actions module 103 of FIG. 1. Sensor 201 may sense a physical property (for example, irradiated heat) or a change thereof and output a signal representative of the sensed physical property or change(s) thereof. Processing means 202 may be used for conditioning (filtering, amplifying, and so on) and processing the signal outputted from and forwarded (shown at 211) by detection means 201. CSD 200 may further include a bi-directional wireless communication module (WCM, shown at 204) for enabling bi-directional communication between an actions module such as actions module 203 and, usually, with a control system such as control panel 210. WCM 204 may include a configuration module (not shown), as a sub-module, that may be adapted to employ configuration information received (shown at 220) from the control system (in this example from control panel 210) through WCM 204.

A security-oriented peripheral control system such as control panel 210 may include a wireless communication module (WCM) such as WCM 213 for enabling communication with a security-oriented peripheral such as CSD 200 through a wireless communication module such as WCM 213. WCM 213 may include, as a sub-module, a configuration module adapted to receive or generate configuration information, and WCM 213 may also be adapted to communicate received (from a third party, not shown) configuration information, or generate and transmit configuration information, to an intended security-oriented peripheral such as CSD 200.

Actions module 203 may differ from actions module 103 because, unlike traditional actions module 103 and in accordance with the present disclosure, actions module 203 of CSD 200 is designed in a way so as to render it configurable by a remote device or system (in this example by control panel 210) to which it is functionally coupled. However, actions module 203 may be similar to actions module 103 to the extent that actions module 203 is also capable of forwarding (shown at 220) security-related actions to control panel 210.

Actions module 203 may forward (shown at 220) actions to, and accept or receive data and/or instructions from, control panel 210 through bi-directional wireless communication module (WCM) 204, which WCM 204 is capable of exchanging data with bi-directional WCM 213 of control panel 210. For example, WCM 204 may transmit an action message to WCM 213, and, responsive to the receipt of the action message, WCM 213 may transmit to WCM 204 a “message-receipt” confirmation signal or a “communication failure” signal, depending on the circumstances. WCM 213 may transmit to WCM 204 other, or additional, message(s), as necessary, required or desired, for example “the message has been successfully dealt with”. Bi-directional WCMs 204 and 213 may communicate with each other over a wireless communication path, though they may be adapted to do so over a wired communication path.

As is explained earlier, security detectors such as security detector 200 may be remotely configured (for example by or through control panel 210) to operate in one of several modes of operation. The ability to remotely switch between modes of operation is schematically designated as 221, 222 and 223, where reference numeral 221 may represent the ability to remotely change the sensitivity of sensor 201, reference numeral 222 may represent the ability to remotely change the way the output signal of sensor 201 is manipulated, and reference numeral 223 may represent the ability to remotely select the action(s) to be reported, and/or the conditions for reporting selected action(s).

As opposed to reference numeral 120 which indicates an exemplary 1-way security system, reference numeral 220 indicates an exemplary 2-way security system in accordance with the present disclosure, which exemplary 2-way security system is shown including a control panel (shown at 210) and one, demonstrative, wireless peripheral (shown at 200). Exemplary wireless peripheral 200 is, according to the demonstration, a detector. However, the wireless peripheral may be a keypad, key fob, repeater, and so on. In addition, exemplary control panel 210 may likewise be functionally coupled to additional or other one or more wireless peripherals.

Alternate embodiments may include more modules, less modules, other modules, and/or functionally equivalent modules. For example, the tasks of Actions module 203 and WCM 204 may be performed using a common module. For example, Actions module 203 may be an actions module such as Actions module 103, to which a corresponding wireless (or other) receiver has been added to facilitate the bi-directional (2-way) communication between security detector 200 (or any other peripheral, for that matter) and control panel 210 (for example).

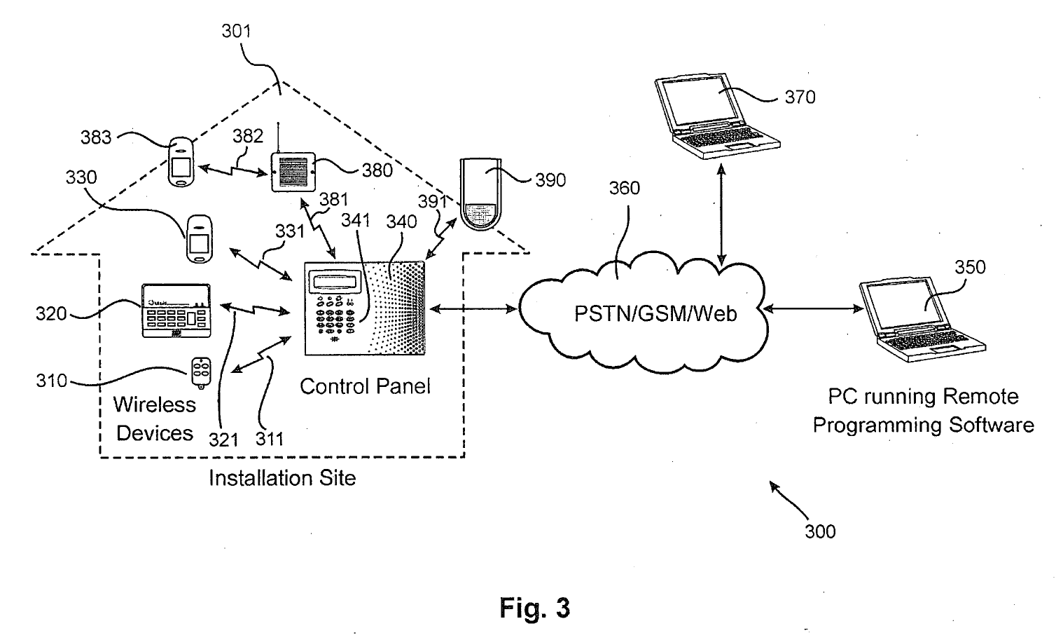

Referring now to FIG. 3, an exemplary 2-way security system (generally shown at 300) is schematically illustrated and described. Exemplary 2-way security system 300 is shown including exemplary wireless peripherals 310, 320, 330, 380 and 390, which are schematically shown wirelessly and bi-directionally coupled to control panel 340 over wireless communication channels 311, 321, 331, 381, and 391, respectively Control panel 340 may function like control panel 210.

Wireless peripheral 310 may be, for example, a wirelessly configurable key fob. Wireless peripheral 320 may be, for example, a configurable wireless keypad (CWK) that may function like integral keypad 341 of control panel 340, but wirelessly. Wireless peripheral 330 may be, for example, a CSD, which may be, for example a wirelessly configurable PIR motion detector, smoke detector, and so on. Wireless peripheral 380 may be, for example, a configurable wireless repeater (CWR) (shown coupled, at 382, to exemplary wireless peripheral 330 which may be, for example, a CSD). Wireless peripheral 390 may be, for example, a configurable wireless siren.

Control panel 340 may be functionally coupled to configuring Personal Computer (PC) 350 over a data network 360, which may be Plain Simple Telephone Network (PSTN), Global System for Mobile (GSM) Communications, an Internet Protocol (“IP”) data network, and so on. Control center 370 may receive from control panel 340, over data network 360, messages regarding alarm conditions within installation site 301. Configuring PC 350 may reside, or be part of, control center 370. Alternatively, Configuring PC 350 may reside elsewhere, as is shown in FIG. 3. Configuring PC 350 may function independently of control center 370. In addition, configuring PC 350 may be connected locally; that is, it may be connected to control panel 340 directly, without using a data network such as data network 360.

Wireless peripherals 310, 320 and 330 may work in a traditional manner in a sense that they may transmit alarm messages (and maybe other types of messages, for example codes relating the selection of mode of operation) to control panel 340, and (if required or desired) control panel 340 may forward these messages to control center 370 over data network 360. According to the present disclosure wireless peripherals 310, 320 and 330 may be remotely configured. “Remote configuration” does not necessarily mean that a wireless peripheral (such as wireless peripheral 330) is configured from outside installation site 301 (for example by PC 350), as control panel 340 may configure a wireless peripheral, such as peripherals 310 and 330, locally, by either using wireless keypad 320 or integral keypad 341 or a PC directly connected to the control panel over serial interface. In all cases, however, a wireless peripheral will not have to be opened for configuration purposes, as opposed to conventional peripherals.

### Remote PIR Motion Detector Configuration

Modern PIR motion detectors offer a wide range of configuration options. Using bi-directional communication modules such as bi-directional communication modules 204 and 211 enables remote and automatic selection of configuration options. PIR sensors are typically installed at a height of approximately two meters above ground, so that manual configuration of a PIR usually involves using a ladder, opening the housing and dealing with jumpers and/or DIP-switches that may be awkward to handle. Therefore, remote configuration may also be perceived as an advantage even if the installer has to be at the installation site.

In respect of a PIR detector, the following configuration options may be remotely handled by a remote device (such as control panel 210 of FIG. 2):
1. “Pulse Count” is a configurable parameter that determines how many infrared beams (of the involved PIR) need to be crossed (by a moving heat irradiating body) in order for the PIR to trigger, or switch on, an alarm. Typically, PIR motion detectors offer 1, 2 or 3 pulses detection, where the 1-pulse option is the most sensitive, which means that an alarm signal will be generated by the PIR if a single beam gets crossed. Additionally, the involved control panel can be instructed to change the configuration of the pulse count (for example from 1-pulse option to 2-pulse option) according to the system status. For example, the pulse count option may differ for different arming methods.
2. “Range Selection” defines the detection range; that is, the “range selection” option allows to increase or decrease the coverage range/distance within which the PIR detector may detect a motion. This is typically achieved by adjusting the sensor's detection sensitivity threshold(s). Detection sensitivity threshold(s) determine(s) the detector's input level required to generate a valid output pulse.
3. “Walk Test”—Battery powered PIR detectors are usually designed to regularly delay transmission(s) of pulses in order to reduce the total number of pulse transmissions for extending the battery's life. In general, the number of pulse transmissions allowed for a wireless, battery-powered PIR detector, can be set according to the application involved. A wireless PIR detector may be configured to transmit an alarm pulse once every four minutes or once every three minutes. However, walk test mode cancels the transmission delay and enables a more effective test of the PIR detector. Some control panels include a “Walk Test” mode that can automatically set (all or some) PIR detectors to “Walk Test” mode and switch them back to a regular mode of operation at the end of the test session.

In general, it is recommended that end users (home owners, business proprietors, and so on) test their PIR detector(s) periodically. Therefore, enabling a remote configuration of a PIR detector is advantageous also in respect of the periodical testing of the PIR detector, as the PIR's housing is not designed, nor it is intended, to be opened by end users.
4. LED Indication—LED indicator(s) of a PIR detector is/are typically used as status indication such as motion detection, warm-up sequence and trouble conditions (for example a PIR failure). Generally, it is not recommended for LED indication to be enabled during normal operation, so that potential intruders will not be able to determine, among other things, the detection pattern when the system is disarmed. Therefore, enabling a remote configuration of a PIR detector is advantageous also in respect of the ability to remotely and/or automatically control the LEDs' enable and disable modes of operation, for example according to the status (for example Walk Test mode) of the PIR detector.
5. “Alarm Memory” is a feature intended to provide local indication on the PIR detector after the occurrence of an alarm. Traditionally, after an alarm condition is detected, a person may disarm the involved security system and the involved LED indicator(s) on the PIR detector that was activated. Traditionally, the involved LED indicator(s) flash(es) until the system is rearmed. This feature is a useful indication for end user(s) as it directly indicates to end user(s) the exact initiator(s), or cause, for the alarm. Alarm memory is a feature commonly used by, or in association with, hardwired PIR detectors, but this feature cannot be used in traditional wireless PIR detectors; that is, this feature cannot be used in PIR detectors that can only send information (for example to a control panel) but cannot be remotely configured nor they can “talk” to a remote control panel (by exchanging data there between). The reason for the latter distinction is that the alarm memory feature relies upon the PIR detector knowing the arm/disarm status of the security system (for example), and this kind of feature can be implemented in a 2-way wireless security system; that is, only in a wireless security system in which a PIR detector (such as the PIR detector disclosed herein) and the involved control panel (for example) can exchange data with one another. This feature is implemented by the control panel (for example) transmitting the system arm/disarm status to the PIR detector, which transmission is not possible with traditional (one-way) PIR detectors. As part of the present disclosure an alarm memory indication may be reset automatically (when the system is rearmed) or it may be performed manually through a control panel, by sending a corresponding command.
6. “Trouble Reset”—Certain system standards require that a troublesome PIR detector shall prevent a person from arming the security system. According to other system standards a troublesome PIR detector must be checked before the trouble condition is reset. For example, standards known generally as the VdS standards require that if a PIR detector recognizes an attempt to mask, wrap, distort or otherwise interfere with its lens, the PIR detector must be tested before the trouble condition is reset, because a solvent (for example) may be used by a potential intruder to wrap or distort the PIR's lens for deteriorating the lens's optical characteristics. Therefore, it is not sufficient that the user involved gets notified of the trouble event. The involved user must also test the PIR detector in order to enable the resetting of the PIR detector, after which reset the user may arm the security system. Using a 2-way wireless system, in the way disclosed herein, may allow the PIR detector to be remotely instructed (by or through a control panel) to enter a walk test mode and, thereafter, to send a trouble restore message to the control panel after the PIR detector successfully passes the test. Verband der Sachversicherer (VdS) is an association of major German insurance firms. The VdS tests security equipment publishes guidelines and issues certificates to those firms and for those products that meet the VdS's standards. Because of the VdS restrictions, most intrusion alarms, for instance, are sold and installed by professional installers.

### Remote Keypad Configuration

Configuration options associated with keypads generally concern end-user preferences and the specific security application involved. Keypad Configuration options often include configuration of:
1. “Audible Indication”—A 2-way keypad is able to audibly indicate changes in the status of the security system. For example, the keypad may sound tone(s) to indicate that the entry delay is counting down, and an additional series of tone(s) to indicate that the system has been successfully disarmed. Sometimes, however, the user may want to mute audible indication(s) on a specific keypad for being disturbing. Tones disturbances may occur, for example, because the keypad is installed too close to sleeping areas. In many cases, complaints for tones disturbances are submitted after completing the installation of the system. During installation, however, the person using the system did not foresee a problem with the keypad location and, after a while, the user may feel very uncomfortable with the keypad location. Using a 2-way wireless system in the way disclosed herein enables the person using the system to remotely configure the keypad so as to mute some or all of the keypad tones, whether temporarily, during certain periods, or permanently. The keypad may be instructed (by or through a control panel) to automatically mute tones according to the time of the day during which the house residents are usually, or expected to be, asleep. For instance, a given keypad may be configured not to sound tones between 20:00 and 07:00 the following morning.
2. “Backlight”—Often, keypads include backlit silicone rubber keys in order to help the user see the keys when it is dark. Because backlit silicone rubber keys of a keypad consume an extra energy from the power source (usually a battery) feeding the PIR detector, they tend to shorten the battery's life. However, using the 2-way wireless system, as is disclosed herein, allows to remotely enable or disable the keypad backlight as required, or to automatically control the backlight level according to time of day or system status. For example, the keys' backlight may be disabled at all times except at times during which there is AC (Alternate Current) power loss (there is a power failure in the premises). The keypad backlight may be instructed to light up during the entry delay, which will enable the user to see the keypad's keys, which may prevent false alarms caused by the user failing to disarm the system in a dark environment.

### Remote Repeater Configuration

A repeater is typically used to extend the range of device's transmitters in installations where the environmental characteristics (distance(s), obstacles, and so on) may be problematic from wireless communication perspective. Sometimes, environmental conditions may severely interfere with, reduce, or limit, or otherwise detrimentally affect, the operational wireless range of transmitters. In the context of the present disclosure a repeater functionally intermediates between one or more wireless detectors, or peripherals, and a central control panel; that is, traditionally, repeaters may simply relay communications from wireless devices (for example wireless detectors or sensors) to the involved control panel. An alternative paradigm may be adopted, which may involve registering wireless peripheral(s) in the involved control panel and in the involved repeater.

According to this paradigm each wireless peripheral has a unique identification data, and registering a peripheral means that the control panel is adapted to identify, or is capable of identifying, a peripheral by using the peripheral's unique identification data. This way, a given control panel “knows” which peripherals are associated with it. If a given control panel receives a transmission from a peripheral which is not registered in (not “known” to) the given control panel (for example because the peripheral is associated with a different control panel), the given control panel ignores the transmission. Registration of a peripheral in a control panel generally includes setting the panel to be in “registration mode”, and forcing the peripheral to transmit to the control panel at least two identical transmissions. After receiving (by the control panel) from the peripheral two identical transmissions while the control panel is in “registration mode”, the peripheral is said to be, or deemed, registered in the control panel. Peripherals that located relatively far away from the control panel should use wireless range extender i.e. wireless repeater. In order the repeater will re-transmit signals of only allowed peripherals, these peripherals should be registered in the repeater the same way as in the control panel. After the registration of the peripheral, the repeater may filter unnecessary transmissions, meaning that the repeater will ignore received transmissions which do not belong to any peripheral that is registered in the repeater. This way the repeater will block any message that will be transmitted by detector(s) belonging, for example to neighboring apartments, from reaching the control panel.

Traditionally, registering and un-registering (deleting) transmitters in the repeater may involve on-site programming, which means that the installer, or a programmer, has to be at the installation location and use a programming keypad. However, according to the present disclosure a remotely configurable repeater may be used, which allows remote configuration of a repeater, for which reason there is no need for a programming keypad.

### Transmitter Registration, Deletion and Viewing

In order to extend the range of a peripheral's, or WCM's, transmitter, the transmitter has to be “known” (by registration) both to the involved repeater and control panel. Traditionally, registering a transmitter is done manually by the installer, and a manual registration of a transmitter typically involves two registration procedures: a first registration procedure for registering the transmitter in the control panel, and a second registration procedure for registering the transmitter in the repeater.

According to the present disclosure the system's installer may choose which transmitter(s) will communicate with a control panel through a repeater, by correspondingly configuring the involved peripheral(s), optionally from a remote location. If a given peripheral has been configured to communicate with a control panel through a repeater, the control panel may automatically update the repeater with the peripheral's unique identification data, thereby registering the peripheral in the repeater while eschewing a direct peripheral-repeater registration process. A repeater and a control panel may each have a registration list associated with it, which registration list may include, among other things, unique identification (ID) data of registered peripherals.

In a similar manner a system's installer may also delete a device (peripheral) from a repeater's registration list, by sending an instruction to the repeater to remove the peripheral's unique ID from its registration list. According to the present disclosure a system's installer may view the registration lists in the repeater and in the control panel by using a personal computer (PC) (for example) that may be functionally connected to the control panel or repeater directly or indirectly, by using any wireless or wired communication path. According to the present disclosure the control panel, repeater and peripherals may display, or otherwise provide the system's installer (for example) with, data indicative of the relative signal's strength associated with received configuration and/or control transmission(s). Signal strength may be evaluated, for example by using ‘n’ last transmissions from a remote location. In general, “signal strength” indicates herein how well a wireless transmission, which is sent by a peripheral to a control panel or repeater, or from a control panel to a peripheral or repeater, is received by the corresponding, or intended, device (control panel, repeater, peripheral, and so on).

### Transmitter Registration, Deletion and Viewing

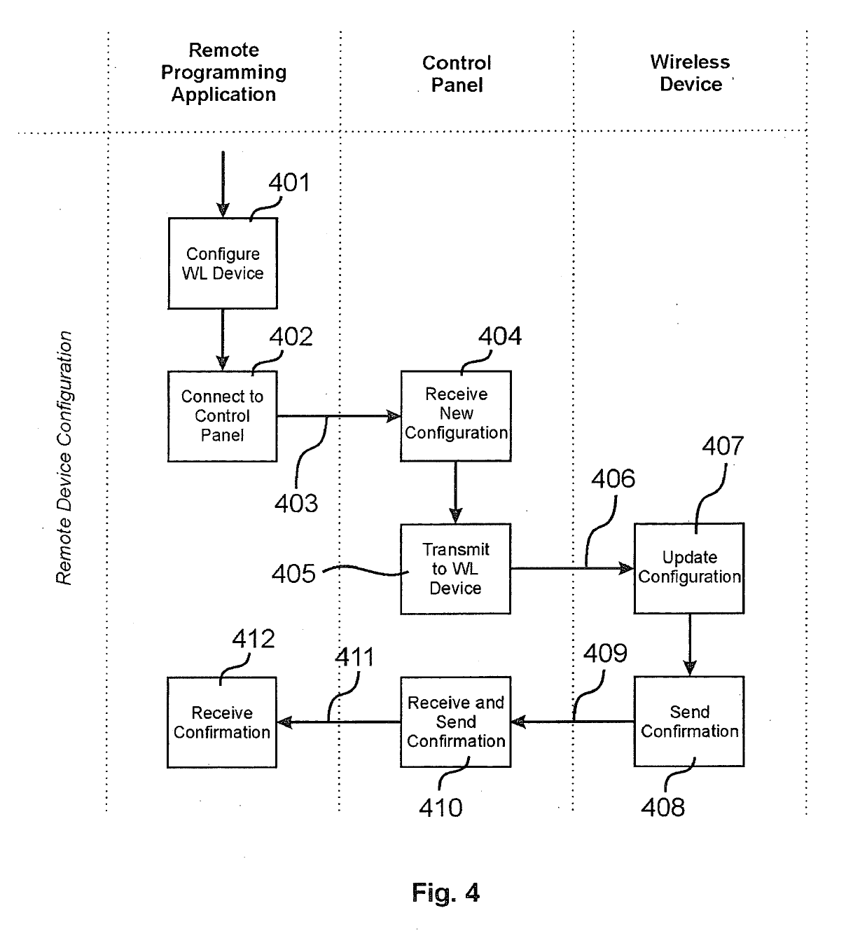

Referring now to FIG. 4, a remote device configuration method is shown and described in accordance with the present disclosure. If a given wireless device has to be configured (such as immediately after being installed) or reconfigured (such as because of its poor, or inadequate, performance), a personal computer (PC) such as PC 350 of FIG. 3 (or other appliance connected directly to the control panel through a serial interface or remotely over a communication channel such as PSTN, GSM, GPRS, Broadband, and so on), which may run a Remote Programming Application (“RPA”), may receive a configuration instruction (“Configure WL Device”, shown at 401, “WL” standing for “wireless”) to configure (or reconfigure) the intended wireless device.

Responsive to the reception of the configuration instruction the configuring PC (for example PC 350), or appliance, may connect (“Connect to Control Panel”, shown at 402) to the control panel with which the intended wireless device is, or may be, in communication. Then, the control panel may receive (shown at 403) from the configuring PC (for example) or appliance an updated or a new configuration file (“Receive New Configuration”, shown at 404) or configuration data, together with identification details/data unique to the wireless device whose configuration is to be updated, modified or replaced. The control panel may then transmit (“Transmit to WL Device”, shown at 405) the updated, modified or new configuration file or data to the wireless device specified in the device's unique identification details. Upon receiving (shown at 406) the updated, modified or new configuration file or data from the control panel, the intended wireless device updates its configuration (“Update Configuration”, shown at 407) data.

After the intended wireless device updates its configuration file or data (shown at 407) it may send (shown at 408) confirmation or acknowledge message to the control panel to confirm the execution of the task. The control panel may receive (shown at 409 and 410) from the wireless device (peripheral) the confirmation or acknowledge message and forward (shown at 410 and 411) the message to the PC or appliance with which the control panel is in communication. The PC, or appliance, may receive (shown at 412) the confirmation or acknowledge message forwarded to it through the control panel.

### Standby and Shutdown

A drawback of 1-way wireless systems is that traditional wireless devices (for example a wireless PIR) are not aware of the current system's status. A consequence of this incapability is that the wireless devices function in the same way substantially at all times, regardless of the system's status. For example, a PIR motion detector may traditionally continue to detect motion and to transmit corresponding alarm messages to the related control panel, which control panel may not be able to receive, or to handle, these alarm messages because the control panel is in a mode of operation that ignores PIR transmissions (such as when the control panel is in “DISARM” mode). Transmitting messages to a control panel that ignores them results in wasting battery power and, in addition, such transmissions may interfere with transmissions from other devices to the common control panel.

By using a 2-way wireless system in the way disclosed herein, the control panel can remotely control the wireless peripheral devices mode of operation based on the current system status and the type of each wireless peripheral and its function. If the current status (or operation mode) of the system is such that no input is required from a given wireless device, the given wireless device may get a control (or configuration) message telling it to enter into a standby mode, during which mode the given wireless device will stop transmitting alarm transmissions.

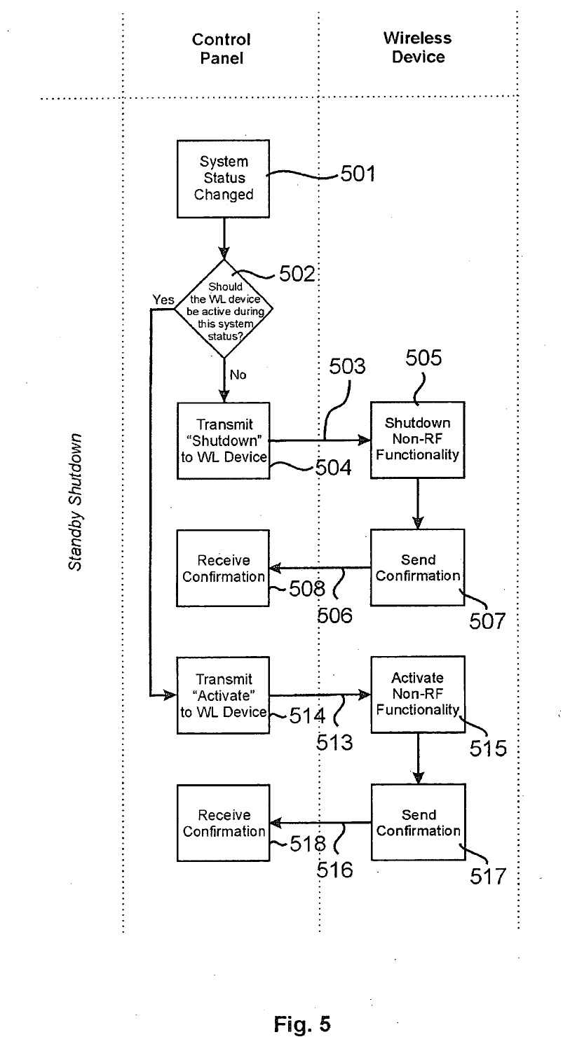

Referring now to FIG. 5 a wireless peripherals standby and shutdown method is shown and described in accordance with the present disclosure. In some cases, the wireless devices' current active mode of operation may depend on the control panel's status and the way the wireless device is currently configured in the control panel. For example, one PIR detector may be configured in the control panel as “Normal” function or type, while a second PIR may be configured in the control panel as “24-Hours” type. These two exemplary types (“Normal” and “24-Hours” types) of devices may cause the involved control panel to respond differently to alarm messages received from these devices, depending on the system (control panel) status.

“Normal” type means herein that the control panel should react (respond) to an alarm message from the PIR (for example) only if the system (the control panel) is armed; that is, the control panel is in “ARM” mode. Otherwise, the control panel should ignore the alarm message. “24-Hours” type means herein that the control panel should respond to alarm messages from the PIR (for example) regardless of the control panel's status; that is, regardless of whether the control panel is in “ARM” or “DISARM” mode.

Essentially every time the status of the security system changes (“System Status Changed”, shown at 501) it is checked for every wireless peripheral (at 502) whether the wireless device should be active in this system's state. If the device should be active at that system state (shown as “Yes” at 502), the control panel may transmit (schematically shown at 509) an “Activate” message (“Transmit “Activate” to WL Device”, shown at 514) to the wireless device. Upon receiving (shown at 513) an “Activate” message, the wireless device may activate non-RF (Radio Frequency) circuit elements or modules (“Activate Non-RF Functionality”, sown at 515). As, during or after, the “Activation” command is executed by the wireless device (peripheral), the wireless device may send (shown at 517 and 516) a “confirmation” or “Acknowledge” message to the control panel, which receives (shown at 518) the confirmation” or “Acknowledge” message.

However, if the device should not be active in that system state (shown as “No” at 502), the system may transmit (shown at 503) a “Shutdown” message (“Transmit “Shutdown” to WL Device”, shown at 504) to the wireless device. Upon receiving (shown at 503) a “Shutdown” message, the wireless device may shutdown the non-RF circuit elements or modules (“Shutdown Non-RF Functionality”, sown at 505. As, during or after, the “Shutdown” command has been is executed by the wireless device (peripheral), the wireless device may send (shown at 507 and 506) a “confirmation” or “Acknowledge” message to the control panel, which receives (shown at 508) the confirmation” or “Acknowledge” message.

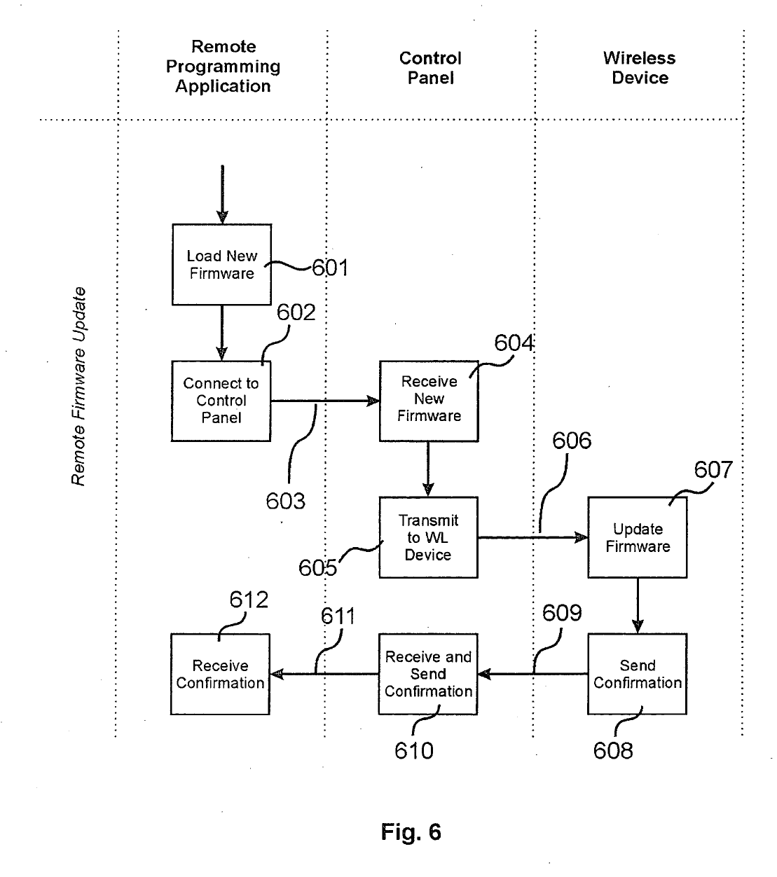

Referring now to FIG. 6, a remote firmware update method is shown and described in accordance with the present disclosure. If the firmware of a given wireless device has to be modified, changed, replaced or updated, a PC (such as PC 350 of FIG. 3), or any other appliance, running, for example a Remote Programming Application (RPA) may receive a modification, change, replacement or update instruction (“Load New Firmware”, shown at 601) to modify, change, replace or update the firmware, or application software, of the intended wireless device. Responsive to the reception of the “Load New Firmware” instruction, the configuring PC (for example PC 350), or other appliance, may connect (“Connect to Control Panel”, shown at 602) to the control panel with which the intended wireless device is, or may be, in communication. Then, the control panel may receive (shown at 603) from the configuring PC or other appliance an updated or a new firmware file (“Receive New Firmware”, shown at 604), together with device identification details of the wireless device whose firmware is to be updated, modified or replaced. The control panel may then transmit (“Transmit to WL Device”, shown at 605) the updated, modified or new firmware file to the wireless device specified in the device identification details. Upon receiving (shown at 606) the updated, modified or new firmware file from the control panel, the intended wireless device may send a confirmation or acknowledge message (shown at 608 and 609) to the control panel to confirm the successful firmware update or modification, or, in a case of an unsuccessful firmware update or modification, a failure message. The control panel may forward this confirmation, or failure, message to the remote PC or appliance (shown at 610 and 611). Upon successful update or modification of it's the wireless device's firmware (“Update Firmware”, shown at 607), the wireless device may start, or restart, its operation using the updated or modified firmware.

### Firmware Updates

The 2-way wireless system may enable a system's installer or any other authorized person to remotely update the firmware, or application software, of already installed wireless devices. This may be useful in software debugging and for adding new features to a device (sometimes a necessary requirement of international standards) and/or enhancing and/or updating and/or substituting existing features with new features.

Traditionally, if a software bug is discovered in the firmware of an already installed device, the system's installer has to visit the installation site, remove the problematic device and return it to the seller for technical inspection or testing, during which inspection or test the software bug may be removed. However, the latter process is costly. Another approach is to upgrade the firmware “on-site” by the installer using a standard programmer device connected to the upgraded product. However, according to the present disclosure the “firmware update” feature allows the system's installer to remotely update the firmware, thus saving time and costs which are traditionally incurred by visiting the system's installation site.

The foregoing description of various embodiments of the present disclosure has been presented for the purposes of illustration and description. It is not intended to be exhaustive or to limit the present disclosure to the precise form disclosed. It should be appreciated by persons skilled in the art that many modifications, variations, substitutions, changes, and equivalents are possible in light of the above teachings. It is therefore intended that the appended claims and claims hereafter introduced be interpreted to include all modifications, permutations, additions and sub-combinations as are within their true spirit and scope.

What is claimed is:

1. A security system comprising:
a control system adapted to remotely configure security-oriented peripherals; and
one or more security-oriented peripherals adapted to be wirelessly configured by said control system.

2. The security system according to claim 1, wherein the control system is adapted to bi-directionally and wirelessly communicate with the one or more security-oriented peripherals.

3. The security system according to claim 1, wherein a security-oriented peripheral is a configurable security detector.

4. The security system according to claim 3, wherein a configurable security detector is a passive Infrared motion detector.

5. The security system according to claim 1, wherein a security-oriented peripheral is a configurable wireless keypad.

6. The security system according to claim 5, wherein a security-oriented peripheral is a key fob.

7. The security system according to claim 1, wherein a security-oriented peripheral is a configurable wireless repeater.

8. The security system according to claim 1, wherein a security-oriented peripheral is a configurable wireless siren.

9. The security system according to claim 1, wherein the control system is further adapted to receive or generate configuration information, and to pass on the received or generated configuration information to an intended security-oriented peripheral.

10. The security system according to claim 9, wherein the control system is further adapted to receive from the security-oriented peripheral “confirmation”, “acknowledge” and “failure” messages associated with the reception and execution of the configuration information by said peripheral.

11. The security system according to claim 1, wherein the control system comprises:
a configuration module adapted to receive or generate configuration information; and
a bi-directional wireless communication module adapted to communicate received or generated configuration information to an intended security-oriented peripheral.

12. The security system according to claim 1, wherein a security-oriented peripheral comprises:
a bi-directional wireless communication module adapted to communicate with the control system; and
a configuration module adapted to employ configuration information received from the control system through said bi-directional wireless communication module.

13. A security-oriented peripheral comprising:
a bi-directional wireless communication module adapted to communicate with a security-oriented peripheral control system; and
a configuration module adapted to employ configuration information received from the control system through said bi-directional wireless communication module.

14. The security-oriented peripheral according to claim 13, wherein the security-oriented peripheral is a passive Infrared motion detector, wireless keypad, wireless key fob or a wireless router.

15. A security-oriented peripheral control system comprising:
a bi-directional wireless communication module adapted to communicate configuration information to a security-oriented peripheral.

16. The peripheral control system according to claim 15, wherein said peripheral is a passive Infrared motion detector, wireless keypad, wireless key fob, wireless repeater or wireless siren.

17. The peripheral control system according to claim 15, wherein said control system is a control panel associated with the security-oriented peripheral.

18. The peripheral control system according to claim 15, wherein said bi-directional wireless communication module is further adapted to receive from the peripheral “confirmation”, “acknowledge” and “failure” messages associated with the reception and execution of the configuration information by said peripheral.
